(19) United States
(12) Patent Application Publication
(10) Pub. No.: US 2022/0234327 A1
(43) Pub. Date: Jul. 28, 2022

(54) DECORATIVE MOLDED BODY AND METHOD FOR MANUFACTURING THE SAME

(71) Applicant: Sumitomo Riko Company Limited, Aichi (JP)

(72) Inventors: Masahiro Onishi, Aichi (JP); Kenji Kimura, Aichi (JP); Takahiro Shinozaki, Aichi (JP); Yasuyuki Miwa, Aichi (JP)

(73) Assignee: Sumitomo Riko Company Limited, Aichi (JP)

(21) Appl. No.: 17/717,118

(22) Filed: Apr. 10, 2022

Related U.S. Application Data
(63) Continuation of application No. PCT/JP2020/011981, filed on Mar. 18, 2020.

(30) Foreign Application Priority Data
Oct. 31, 2019 (JP) 2019-198570

(51) Int. Cl. B32B 3/30; B32B 25/20; B32B 27/38; B32B 27/42; B32B 27/30; B32B 27/36; B32B 27/08; B32B 25/08; B29C 45/14

(52) U.S. Cl. CPC B32B 3/30; B29L 2031/722; B32B 27/38; B32B 27/42; B32B 27/308; B32B 27/365; B32B 27/36; B32B 27/08; B32B 25/08; B29C 45/14508; B32B 2307/412; B32B 2451/00; B32B 2307/4023; B32B 2255/10; B32B 2255/26; B32B 25/20

(57) ABSTRACT

A decorative molded body (1) comprises: a transparent layer (10) having an exposed surface (11) and an uneven back surface (12) on an opposite side of the exposed surface (11); a molded layer (50) disposed to face the back surface (12) of the transparent layer (10); a decorative film (30) formed in a predetermined contour shape, disposed to be sandwiched between the back surface (12) of the transparent layer (10) and the molded layer (50), and formed to follow an unevenness of the back surface (12) of the transparent layer (10), the decorative film (30) being visible through the transparent layer (10) from the exposed surface (11) of the transparent layer (10); and a sealing member (60) disposed in a periphery shape on an outer periphery side of the decorative film (30) and burying an outer periphery edge of the decorative film (30).

### CROSS REFERENCE TO RELATED APPLICATIONS

This application is a Continuation of PCT International Application No. PCT/JP2020/011981, filed on Mar. 18, 2020, which claims priority under 35 U.S.C § 119(a) to Patent Application No. 2019-198570, filed in Japan on Oct. 31, 2019, all of which are hereby expressly incorporated by reference into the present application.

### TECHNICAL FIELD

The present disclosure relates to a decorative molded body and a method for manufacturing the same.

### BACKGROUND ART

Decorative molded bodies such as emblems for automobiles are described in, for example, Patent Documents 1-2. Patent Document 1 describes a decorative molded body comprising a transparent layer that constitutes a surface layer and has an exposed surface, a base material layer provided on the back surface side of the transparent layer, and a decorative film sandwiched between the base material layer and the transparent layer. The decorative film is formed on the uneven back surface of the transparent layer by vacuum forming or vapor deposition.

Patent Document 2 describes a decorative molded body comprising a transparent layer that constitutes a surface layer and has an exposed surface, a decorative layer colored on the uneven back surface of the transparent layer, a sheet-shaped intermediate layer provided on the back surface side of the transparent layer and being of the same material as the transparent layer, and a back surface layer provided on the back surface side of the sheet-shaped intermediate layer and having an attachment portion to a vehicle body. The transparent layer and the sheet-shaped intermediate layer are formed of the same material having high radio wave transmission, and the back surface layer having the attachment portion is formed of a resin having low radio wave transmission in order to obtain impact resistance. The back surface layer is molded by injection molding, and the sheet-shaped intermediate layer is in close contact with the uneven back surface of the transparent layer due to the pressure at the time of the injection, and the back surface layer is integrated with the deformed sheet-shaped intermediate layer. The transparent layer and the intermediate layer are polycarbonate resin or acrylic resin, and the back surface layer is ABS resin.

Further, Patent Document 3 describes a method for manufacturing a cover film integrated silicone rubber molded product. A cover film is sandwiched in a mold, an uncured silicone rubber composition is injected in and fills the cavity of the mold, and after the silicone rubber composition is cured, the mold is opened and the molded product is taken out from the mold. Here, a method of placing the cover film on the cavity of the mold, a method of bringing the cover film into close contact with the cavity surface by vacuum suction or the like, and a method of preforming the cover film to be along the cavity surface are described.

### PRIOR ART DOCUMENTS

### Patent Documents

Patent Document 1: JP 2004-251868 A
Patent Document 2: JP 2019-85083 A
Patent Document 3: JP H8-294940 A

### SUMMARY OF THE INVENTION

### Problem to be Solved by the Invention

From the viewpoint of designability, it is required to prevent the decorative film from protruding from the side surface (outer peripheral surface) of the decorative molded body. However, in general, after molding the decorative molded body, the part of the decorative film that protrudes from the side surface (outer peripheral surface) of the transparent layer is cut. Due to the process of cutting the protruding decorative film the cost is high. Therefore, it is required that the designability can be improved without cutting the decorative film in the final process of manufacturing the decorative molded body.

The present disclosure provides a decorative molded body and a method for manufacturing the same, which can improve the designability without cutting the decorative film in the final process of manufacturing the decorative molded body.

### Means for Solving the Problem

(1. Decorative Molded Body)

A decorative molded body comprises: a transparent layer having an exposed surface and an uneven back surface on an opposite side of the exposed surface; a molded layer disposed to face the back surface of the transparent layer; a decorative film formed in a predetermined contour shape, disposed to be sandwiched between the back surface of the transparent layer and the molded layer, and formed to follow an unevenness of the back surface of the transparent layer, the decorative film being visible through the transparent layer from the exposed surface of the transparent layer; and a sealing member disposed in a periphery shape on an outer periphery side of the decorative film and burying an outer periphery edge of the decorative film.

Here, in order to dispose the decorative film in the desired area on the back surface of the transparent layer, the outer shape of the decorative film is slightly larger than the desired area. However, even if the outer periphery edge of the decorative film protrudes from the desired area to the outer peripheral side, it is buried in the sealing member 60 at the same time as molding the sealing member 60. Therefore, the designability of the decorative molded body 1 can be improved.

(2. A Method of Manufacturing the Decorative Molded Body)

A method for manufacturing the decorative molded body comprises: a film preparation step of molding the decorative film in a planar and predetermined contour shape; a molding preparation step of, in the mold, disposing the transparent layer as an insert and disposing the decorative film of the planar and predetermined contour shape; and a sealing member molding step of, while supplying in the mold a material of the sealing member and molding the sealing member, burying the outer periphery edge of the decorative film in the sealing member. This makes it possible to manufacture a decorative molded body that achieve the above-mentioned effects.

### BRIEF DESCRIPTION OF THE DRAWINGS

FIG. 1 is a perspective view of the decorative molded body.

FIG. 2 is a front view of the decorative molded body, that is, a view seen from the exposed surface side of the transparent layer. In the figure, the black part shows the part where the decorative film is masked, and the white part shows the part where the decorative film is visually recognized. The figure is a view seen from the direction II in FIG. 4.

FIG. 3 is a back view of the decorative molded body and is a view seen from the direction III in FIG. 4.

FIG. 4 is a right-side view of FIG. 2.

FIG. 5 is a V-V cross-sectional view of FIG. 2.

FIG. 6 is a cross-sectional view of the transparent layer, using the same cross-sectional line as in FIG. 5.

FIG. 7 is a view seen from the direction VII in FIG. 6 (a back view of the transparent layer)

FIG. 8 is an enlarged cross-sectional view of the decorative frame, using the same cross-sectional line as in FIG. 5.

FIG. 9 is a cross-sectional view of the frame, using the same cross-sectional line as in

FIG. 5.

FIG. 10 is an overall flowchart showing a method for manufacturing the decorative molded body.

FIG. 11 is a detailed flowchart of a unitization step in a method for manufacturing the decorative molded body.

FIG. 12 is a diagram showing a step of mounting the frame to the intermediate mold.

FIG. 13 is a diagram showing a step of mounting the decorative film to the frame.

FIG. 14 is a diagram showing a state in which the frame and the decorative film are mounted to the intermediate mold.

FIG. 15 is a diagram showing a step of mounting the transparent layer in the lower mold.

FIG. 16 is a diagram showing a state in which the lower mold with the transparent layer attached, the intermediate mold with the frame and the decorative film attached, and the upper mold are disposed at initial positions.

FIG. 17 is a diagram showing a step of vacuuming the lower mold, the intermediate mold and the upper mold with bringing them close each other.

FIG. 18 is a diagram showing a state in which the lower mold, the intermediate mold, and the upper mold are combined.

FIG. 19 is a diagram showing a state in which a molding material is supplied from the upper mold.

FIG. 20 is a diagram showing a step of detaching the upper mold and the lower mold.

FIG. 21 is a diagram showing a step of detaching the intermediate mold.

FIG. 22 is a diagram showing a step of mounting the mounting member on the back surface side of the molded layer.

FIG. 23 is a cross-sectional view of the processed product.

FIG. 24 is a flowchart showing a method of manufacturing the processed product.

### DESCRIPTION OF EMBODIMENTS

(1. Outline of a Decorative Molded Body)

The decorative molded body has a configuration in which a transparent layer is disposed on a surface layer and a decorative film is disposed on the back surface of the transparent layer. The decorative film is made of a colored material. The decorative film has, for example, gloss. The decorative film penetrates the transparent layer and becomes visible to a person from the surface (exposed surface) of the transparent layer.

Further, instead of making the decorative film visible from the entire area of the surface (exposed surface) of the transparent layer, the decorative film may be made visible from only a part by partial masking. In this way, by designing the shape of the transparent layer and the visible portion of the decorative film, it is possible to manufacture decorative molded bodies with various designs.

The decorative molded body can be used, for example, for emblems for automobiles, emblems attached to products, key chains, straps, or the like. The emblems for automobiles are, for example, emblems disposed on the front grill parts of automobiles, emblems disposed on the steering wheels, or the like.

Further, the transparent layer constituting the decorative molded body is intended to have an uneven back surface on the opposite side of the exposed surface in terms of design. The decorative film is formed following the uneven back surface of the transparent layer. By forming the back surface of the transparent layer to be uneven and disposing the decorative film in accordance with the unevenness in this way, a decorative molded body with designability can be obtained.

Furthermore, as compared with the case where a space (gap) is formed between the decorative film and the uneven back surface of the transparent layer, a decorative molded body with a more beautiful design is obtained when the decorative film is formed to neatly follow the uneven back surface of the transparent layer so that no space (gap) exists. Therefore, it is an important element in the design that the decorative film is formed to neatly follow the uneven back surface of the transparent layer. In the present example, no space (gap) is formed between the decorative film and the back surface of the uneven back surface of the transparent layer.

(2. Configuration of the Decorative Molded Body 1)

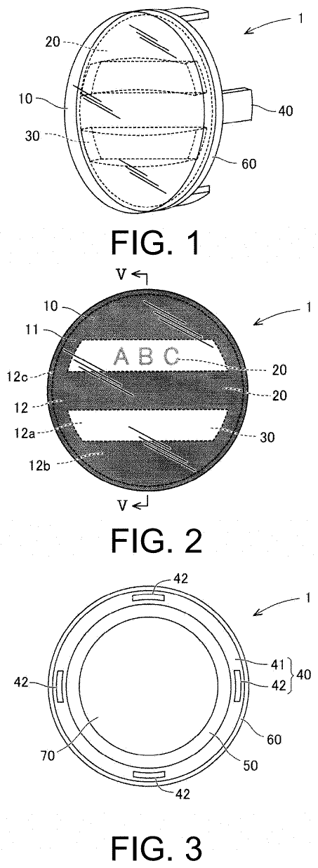

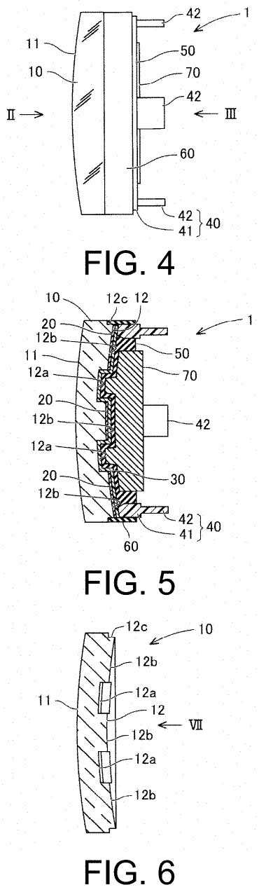

The configuration of the decorative molded body 1 is described with reference to FIGS. 1 to 9. The decorative molded body 1 is described by taking an automobile emblem as an example. The decorative molded body 1 may have an arbitrary shape, although the case where the decorative molded body 1 has a circular shape when viewed from the front is taken as an example.

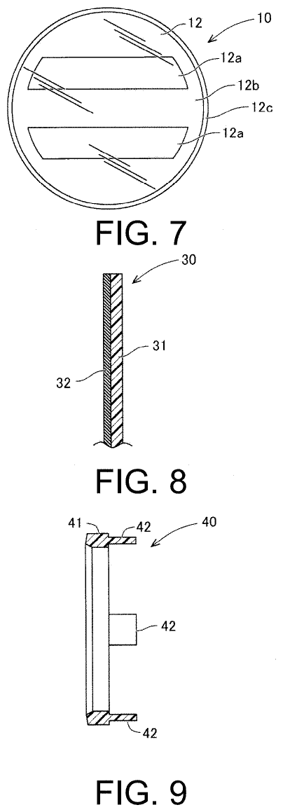

The decorative molded body 1 comprises a transparent layer 10 that constitutes a surface. As shown in FIGS. 6 and 7, the transparent layer 10 is formed in a plate shape having an arbitrary outer shape, for example, a disk shape, an elliptical plate shape, a polygonal plate shape, or the like. The transparent layer 10 is molded from a transparent resin material, a transparent glass material, or the like. The transparent resin material is, for example, an acrylic resin, a polycarbonate resin, a PET resin, or the like. The transparent layer 10 comprises an exposed surface 11 that constitutes the surface, and an uneven back surface 12 on the opposite side of the exposed surface 11. The exposed surface 11 is formed in a curved convex shape, for example, but may be formed in a planar shape, a curved concave shape, or the like.

As shown in FIGS. 5 and 6, the back surface 12 is formed in an uneven shape. The back surface 12 comprises a concave surface 12a and a convex surface 12b at a central portion. The unevenness of the back surface 12 can be appropriately changed according to the design. As will be described later, the concave surface 12a corresponds to the glossy decorative part, and the convex surface 12b corresponds to the masking part of a non-glossy color such as black. Of course, the convex surface 12b may be used as the decorative part, and the concave surface 12a may be used as the masking part. Further, the back surface 12 comprises a concave cutout portion 12c over around all periphery at the outer peripheral edge.

The decorative molded body 1 further comprises a paint layer 20. The paint layer 20 corresponds to the black filled part in FIG. 2 and is disposed on the back surface 12 of the transparent layer 10. The paint layer 20 constitutes a non-decorative part in the sense of distinguishing it from the decorative part. The paint layer 20 is formed of, for example, a non-glossy paint. For example, an acrylic evaporative drying type paint or the like is applied to the paint of the paint layer 20.

By making the paint layer 20 a deep color such as a black color, for example, the design of the decorative part described later can be improved. Here, in the present example, as shown in FIG. 2, the paint layer 20 is disposed at, of the back surface 12 of the transparent layer 10, the entire area of the convex surface 12b and in the character part which is a part of the concave surface 12a. The paint layer 20 is transmissive through the transparent layer 10 and becomes visible to a person from the exposed surface 11 (surface) of the transparent layer 10.

The decorative molded body 1 further comprises a decorative film 30. The decorative film 30 is made of, for example, a glossy material. The decorative film 30 is formed in a predetermined contour shape. In the present example, the decorative film 30 has an outer shape slightly smaller than the outer peripheral surface shape of the transparent layer 10. For example, FIGS. 1 to 3 show a case where the outer peripheral surface shape of the transparent layer 10 is formed in a circular shape and the outer periphery of the decorative film 30 is formed in a circular shape. However, the transparent layer 10 and the decorative film 30 may have any shape. The outer peripheral dimension of the decorative film 30 is substantially the same as or slightly larger than the inner peripheral dimension of the cutout portion 12c of the transparent layer 10.

As shown in FIG. 8, the decorative film 30 comprises a base material sheet 31 and a decorative layer 32. The base material sheet 31 is molded from, for example, an acrylic resin, a non-stretchable PET resin, or the like. The base material sheet 31 may be transparent or may be colored. The decorative layer 32 is formed on the surface of the base material sheet 31. The decorative layer 32 may be formed on only one side of the base material sheet 31, or may be formed on both sides. The decorative layer 32 is molded from, for example, indium. Besides indium, a glossy metal material may be applied to the decorative layer 32, and a glossy resin may also be applied. Further, the decorative layer 32 is not limited to gloss, and may have a color intended for decoration.

Here, it is known that indium will whiten when heat of temperature about higher than, for example, 120° C.−150° C. is applied. Hereinafter, said temperature is referred to as a whitening temperature. That is, it is necessary that indium is not subjected to heat higher than the whitening temperature. As will be described later, the shaping of the decorative film 30 is performed at a temperature lower than the whitening temperature.

The decorative film 30 is formed to follow the unevenness of the back surface 12 of the transparent layer 10. That is, the decorative film 30 is shaped into an uneven shape corresponding to the unevenness of the back surface 12 of the transparent layer 10. However, at the portion where the paint layer 20 is formed, the decorative film 30 is disposed on the back surface of the paint layer 20. That is, the decorative film 30 is adhered to the transparent layer 10. Therefore, at the portion where the paint layer 20 is not applied, the decorative film 30 is transmissive through the transparent layer 10 and becomes visible to a person from the exposed surface 11 (surface) of the transparent layer 10.

The decorative film 30 is in close contact with the back surface 12 of the transparent layer 10 without having a space (gap). That is, since the decorative film 30 is formed to neatly follow the uneven back surface 12 of the transparent layer 10, the design from the exposed surface of the transparent layer 10 becomes very beautiful. Here, the decorative layer 32 is located at the transparent layer 10 side, and the base material sheet 31 is located at the opposite side of the transparent layer 10. That is, the color of the decorative layer 32 is transmissive through the transparent layer 10.

The decorative molded body 1 further comprises a frame 40. The frame 40 is disposed to face the back surface 12 of the transparent layer 10. The frame 40 has a function of supporting other members constituting the decorative molded body 1. Further, the frame 40 functions as a part to be attached to the other member to which the decorative molded body 1 is attached.

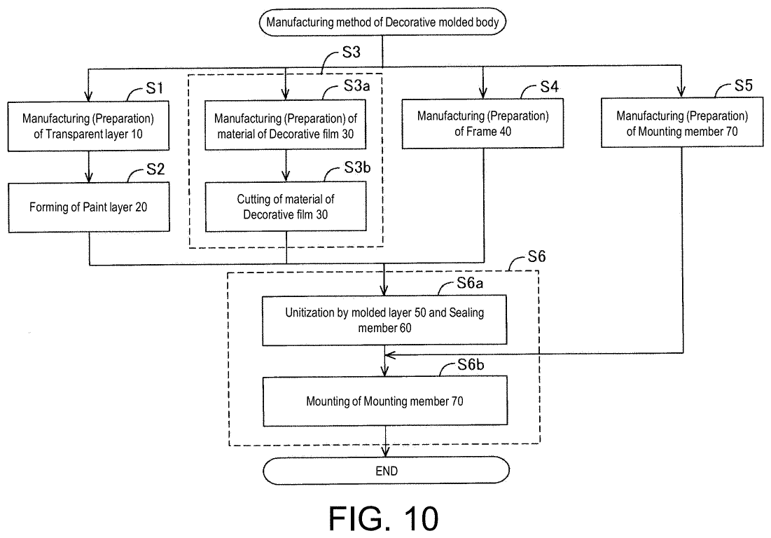

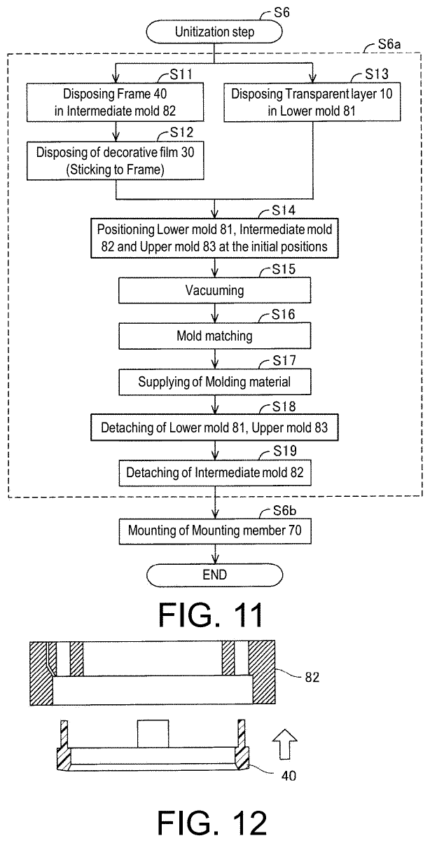

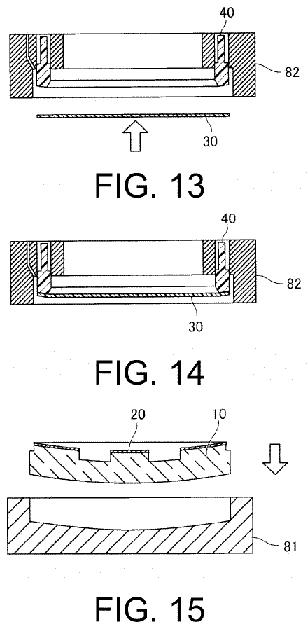

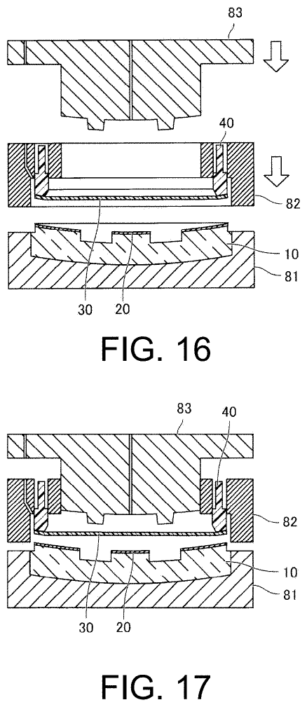

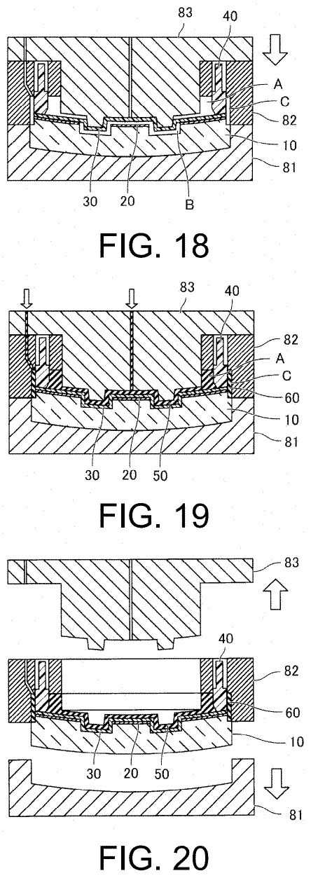

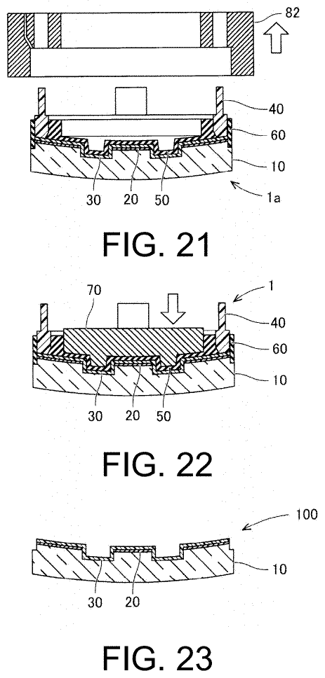

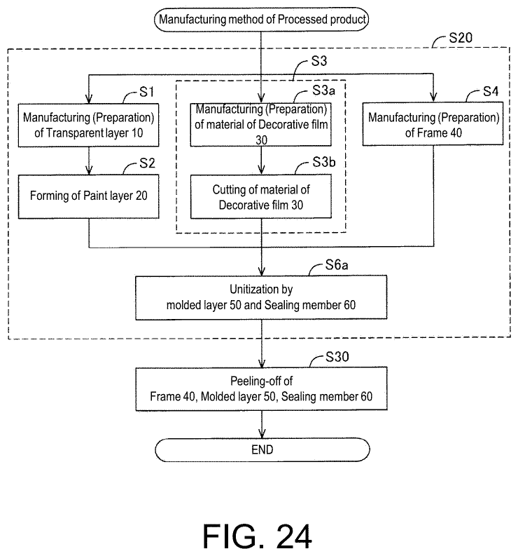

The frame 40 is, as shown in FIGS. 5 and 9, formed in a frame shape. The frame 40 is formed of, for example, a high-strength PET resin, an AES resin, a PBT resin, or the like. The frame 40 may be transparent or may be colored. The frame 40 comprises a frame main body 41 and an attaching member 42 for mounting on an external member. Moreover, the frame main body 41 and the attaching member 42 constitutes one integrated member.

The frame main body 41 is formed in a frame shape. The frame main body 41 is formed in an arbitrary shape continuous in a circumferential direction, for example, a circular frame shape, an elliptical frame shape, a polygonal frame shape (including a quadrangular frame shape, a triangular frame shape, etc.). The frame main body 41 is formed, for example, in a shape corresponding to the outer peripheral surface shape of the transparent layer 10. For example, when the outer peripheral surface shape of the transparent layer 10 is circular, the outer shape of the frame main body 41 is also circular. However, the outer peripheral surface shape of the transparent layer 10 and the outer shape of the frame main body 41 may be different from each other.

In the present example, the outer peripheral dimension (for example, outer diameter) of the frame main body 41 is substantially the same as the inner peripheral dimension (for example, inner diameter) of the cutout portion 12c of the transparent layer 10. That is, one end surface (left surface in FIG. 9) of the frame main body 41 in the axial direction faces the convex surface 12b of the back surface 12 of the transparent layer 10 over the entire circumference. Specifically, one end surface of the frame main body 41 in the axial direction is formed in a shape corresponding to the curved shape of the convex surface 12b of the back surface 12 of the transparent layer 10.

The frame main body 41 is sticked to a part of the back surface of the decorative film 30. In the present example, the frame main body 41 is formed in a frame shape (for example, a circular frame shape or a quadrangular frame shape) corresponding to a predetermined contour shape (for example, a circle or a quadrangle) of the decorative film 30. The frame main body 41 is sticked to the peripheral edge of the decorative film 30 over the entire periphery. That is, the frame main body 41 sandwiches the decorative film 30 between the back surface 12 of the transparent layer 10 (the peripheral edge of the convex surface 12b).

The attaching member 42 is provided so as to protrude at the back surface side of the frame main body 41. A plurality of attaching members 42 are provided, for example, in the circumferential direction of the frame main body 41. In the present example, the attaching members 42 are provided at four locations at equal intervals in the circumferential direction. Further, although not shown, the attaching member 42 may have a locking claw or a locking hole, for example.

The decorative molded body 1 further comprises a molded layer 50. The molded layer 50 is disposed to face the back surface 12 of the transparent layer 10. Specifically, the molded layer 50 is at the back surface 12 side of the transparent layer 10 and is disposed in close contact with the back surface of the decorative film 30. That is, the decorative film 30 is placed to be sandwiched between the back surface 12 of the transparent layer 10 and the molded layer 50.

Thus, the surface side of the molded layer 50 is formed in a shape corresponding to the unevenness of the back surface 12 of the transparent layer 10. On the other hand, the back surface side of the molded layer 50 may have a shape having no unevenness or a shape having unevenness. In the present example, the back surface of the molded layer 50 is formed in the same uneven shape as the unevenness of the back surface 12 of the transparent layer 10. That is, the back surface of the molded layer 50 has a concave surface at a position corresponding to the concave surface 12a of the back surface 12 of the transparent layer 10.

The molded layer 50 is, for example, an injection molded body, that is, a molded body molded by injection molding. The molded layer 50 is molded from, for example, a thermosetting material. Here, the thermosetting material is formed by applying heat and pressure. The molded layer 50 is molded from silicone rubber, epoxy resin, phenol resin, or the like as a thermosetting material. In particular, the molded layer 50 is preferably molded from a viscoelastic material such as silicone rubber, for the purpose of exerting the holding force of the mounting member 70 described later.

Further, as the thermosetting material, a material that can be molded at a temperature lower than the whitening temperature of indium is applied. In particular, as a thermosetting material, silicone rubber that can be molded at a temperature lower than the whitening temperature is suitable. Further, in relation to the molding temperature (whitening temperature), a material taking on a liquid state at room temperature, for example, liquid rubber, is applied as the thermosetting material. However, as the thermosetting material, it is also possible to apply a material taking on semi-solid at room temperature.

Further, as the thermosetting material, a material having translucency can be applied. For example, a translucent silicone rubber can be applied to the thermosetting material. In this case, if a backlight is provided, the light of the backlight passes through the molded layer 50, the decorative film 30 and the transparent layer 10, and a person can visually recognize the light from the exposed surface of the transparent layer 10.

Furthermore, the molded layer 50 is disposed on the inner peripheral side of the frame main body 41. In particular, the molded layer 50 is in close contact with whole circumference of the inner peripheral surface of the frame main body 41. That is, the molded layer 50 is formed along the back surface of the base material sheet 31 of the decorative film 30 and the inner peripheral surface of the frame main body 41, and is formed in a bottomed tubular shape in the present example. A concave place is formed at the center on the back surface side of the molded layer 50.

The decorative molded body 1 further comprises a sealing member 60. The sealing member 60 is disposed on the outer peripheral side of the cutout portion 12c on the back surface 12 of the transparent layer 10. Further, the sealing member 60 is disposed on the outer peripheral side of the frame main body 41. That is, the sealing member 60 is formed in a circumferential shape, that is, over whole circumference at the outer peripheral side of the frame main body 41. In particular, the sealing member 60 is disposed in a state of close contact with the outer peripheral surface of the cutout portion 12c and in a state of close contact with the outer peripheral surface of the frame main body 41. That is, the sealing member 60 has a function of sealing between the back surface 12 of the transparent layer 10 and the frame main body 41.

Here, as described above, the decorative film 30 is disposed to be sandwiched between the back surface 12 and the frame main body 41 of the transparent layer 10. Moreover, the sealing member 60 is disposed to straddle the back surface 12 of the transparent layer 10 and the frame main body 41. Thus, the sealing member 60 buries the outer peripheral edge of the decorative film 30. Therefore, the sealing member 60 has a sealing function and also has a function of improving design by burying the outer peripheral edge of the decorative film 30.

The sealing member 60 is preferably molded from, for example, a thermosetting material. However, the sealing member 60 may also be molded from a thermoplastic material. The sealing member 60 may be molded from the same material as the molded layer 50, for example. That is, the sealing member 60 is molded from silicone rubber, epoxy resin, phenol resin, or the like. The sealing member 60 is molded from a material taking on a liquid state at room temperature.

Here, the sealing member 60 is adhered directly to the cutout portion 12c of the back surface 12 of the transparent layer 10. That is, the sealing member 60 is visually recognized from the exposed surface which is the surface of the transparent layer 10. Therefore, it is preferable to use a coloring material for the sealing member 60. In particular, the sealing member 60 does not appear to have a boundary line at the boundary between the sealing member 60 and the paint layer 20 by making the color the same as that of the paint layer 20.

That is, it is preferable that the sealing member 60 is the same color as the paint layer 20. On the other hand, the molded layer 50 may be a translucent material as described above. In this case, the sealing member 60 and the molded layer 50 have different colors. Of course, if the molded layer 50 does not have translucency, the sealing member 60 and the molded layer 50 may have the same color.

The decorative molded body 1 further comprises a mounting member 70. The mounting member 70 is, for example, a functional component such as an electromagnetic wave radar device or the like. The mounting member 70 is detachably mounted on the back surface side of the molded layer 50. In particular, the mounting member 70 is mounted in the concave place at the back surface side of the molded layer 50. Here, when the molded layer 50 is a viscoelastic body molded from a viscoelastic material, the mounting member 70 is firmly held by the viscoelastic force of the molded layer 50. The housing of the mounting member 70 is molded from, for example, AES resin, polycarbonate resin, acrylic resin, or the like.

(3. Manufacturing Method of the Decorative Molded Body 1)

A method of manufacturing the decorative molded body 1 will be described with reference to FIGS. 10 to 22.

(3-1. Overall Flow of the Manufacturing Method)

The overall flow of the method for manufacturing the decorative molded body 1 will be described with reference to FIG. 10. The transparent layer 10 is manufactured (S1: transparent layer preparation step). The transparent layer 10 is molded by, for example, injection molding. Subsequently, the paint layer 20 is formed at a predetermined position on the back surface 12 of the transparent layer 10 (S2: paint layer forming step).

Further, the decorative film 30 is manufactured (molded) in parallel with the manufacturing of the transparent layer 10 (S3: film preparation step). The decorative film 30 here is formed into a planar and predetermined contour shape. First, in the film preparation step, a strip-shaped sheet which is a material of the decorative film 30 is manufactured (S3a: strip-shaped sheet preparation step). Then, in the film preparation step, by cutting out a predetermined outline shape from the strip-shaped sheet, the decorative film 30 of the planar and predetermined contour is obtained (S3b: film cut step).

Further, the frame 40 is manufactured in parallel with the manufacturing of the transparent layer 10 and the manufacturing of the decorative film 30 (S4: frame preparation step). The frame 40 is molded, for example, by injection molding. Further, the mounting member 70 is manufactured (S5: mounting member preparation step).

Subsequently, the transparent layer 10, the decorative film 30, a frame 40 and a mounting member 70, each of which manufactured in parallel, are unitized by molding the molded layer 50 and the sealing member 60 (S6: unitization step). First, in the unitization step, a primary unit is manufactured by disposing the transparent layer 10, the decorative film 30 and the frame 40 in a mold and by molding the molded layer 50 and the sealing member 60 (S6a: primary unit manufacturing step). Here, the molded layer 50 and the sealing member 60 are molded by, for example, injection molding. The transparent layer 10 and the frame 40 serve as inserts in molding the molded layer 50 and the sealing member 60. Subsequently, in the unitization step, the mounting member 70 is mounted on the primary unit (S6b: secondary unit manufacturing step).

As described above, in the film preparation step (S3), the decorative film 30 is molded in a planar and predetermined contour shape. That is, when the decorative film 30 is cut into a predetermined contour shape in a planar shape, the yield of a single piece of the decorative film 30 can be increased. Since the decorative film 30 is relatively expensive among the constituent members of the decorative molded body 1, the cost of the decorative molded body 1 can be effectively reduced by increasing the yield of the decorative film 30.

Further, since the transparent layer 10 and the frame 40 are inserts, they are pre-molded elements. Further, the decorative film 30 is also pre-molded in the film preparation step (S3). That is, the transparent layer 10, the frame 40 and the decorative film 30 are each pre-molded. Then, in the unitization step of molding the molded layer 50 and the sealing member 60, the transparent layer 10, the frame 40 and the decorative film 30 are integrated. Therefore, the manufacturing steps related to the transparent layer 10, the frame 40 and the decorative film 30 can be made into parallel manufacturing lines. Hence, the yield of the decorative molded body as a product can be increased as compared with the production line in which each process is in a series.

(3-2. Unitization Step)

Next, details of the unitization step (S6) are described with reference to FIGS. 11 to 22. As shown in FIG. 12, the frame 40 is disposed in an intermediate mold 82 (S11: frame disposition step). Subsequently, as shown in FIG. 13, a part of the back surface of the decorative film 30 is sticked to the frame main body 41 of the frame 40 (S12: sticking step). Then, as shown in FIG. 14, the frame 40 with the decorative film 30 sticked is attached to the intermediate mold 82. The decorative film 30 at this time maintains a planar shape. Here, the decorative film 30 may be sticked before the frame 40 is disposed on the intermediate mold 82.

As shown in FIG. 15, the transparent layer 10 is disposed in the lower mold 81 in parallel with the preparation with respect to the intermediate mold 82 (S13: transparent layer disposition step). Subsequently, as shown in FIG. 16, the lower mold 81, the intermediate mold 82 and the upper mold 83 are positioned at the initial positions (S14: molding preparation step). At this time, the transparent layer 10 and the frame 40 are disposed in the molds 81, 82, 83 as injection molding inserts. Further, the decorative film 30 is disposed in a state of maintaining a planar shape. Here, the lower mold 81, the intermediate mold 82 and the upper mold 83 are preheated to a predetermined temperature, for example, 80° C. to 120° C.

Subsequently, as shown in FIG. 17, the intermediate mold 82 and the upper mold 83 are moved to the lower mold 81 side. At this time, since the decorative film 30 is not in contact with the transparent layer 10 nor the upper mold 83, it maintains a planar shape. Then, in the state shown in FIG. 17, vacuuming is performed in the region between the transparent layer 10 attached to the lower mold 81 and the decorative film 30 as well as the region between the decorative film 30 and the upper mold 83 (S15: vacuuming step). Therefore, the lower region and the upper region of the decorative film 30 are in a vacuum state.

Subsequently, as shown in FIG. 18, mold matching of the lower mold 81, middle mold 82 and the upper mold 83 is performed (S16: mold matching step). That is, the outer peripheral edge on the upper surface of the lower mold 81 and the outer peripheral edge on the lower surface of the intermediate mold 82 come into contact with each other. Further, the outer peripheral edge on the upper surface of the intermediate mold 82 and the outer peripheral edge on the lower surface of the upper mold 83 come into contact with each other. At this time, the decorative film 30 partially contacts the back surface 12 of the transparent layer 10 attached to the lower mold 81 and the lower surface of the upper mold 83. Specifically, the decorative film 30 comes into contact with the lower protrusion of the upper mold 83 and is pressed further downward. Therefore, the decorative film 30 is deformed into an uneven shape.

Here, after the mold matching, in the molds 81, 82 and 83, the transparent layer 10, the frame 40 and the decorative film 30 are disposed. The transparent layer 10 and the frame 40 are disposed in the molds 81, 82 and 83 as inserts for injection molding. In the molds 81, 82 and 83, the center upper cavity A is formed by the upper mold 83, the decorative film 30 and the frame 40. Further, the center lower cavity B is formed by the transparent layer 10 and the decorative film 30. Moreover, the outer peripheral cavity C is formed by the intermediate mold 82, the cutout portion 12c of the back surface 12 of the transparent layer 10 and the frame 40.

Here, as described above, the molds 81, 82 and 83 are heated to a predetermined temperature. Therefore, the decorative film 30 is easily deformed by the heat of the molds 81, 82 and 83. Further, when the decorative layer 32 of the decorative film 30 is formed of indium, whitening of indium can be prevented by setting the temperature of the molds 81, 82 and 83 to be equal to or lower than the whitening temperature of indium.

Subsequently, as shown in FIG. 19, from the center of the upper mold 83, the molding material of the molded layer 50, i.e., a thermosetting material is supplied to the center upper cavity A in the molds 81, 82 and 83 (S17: film forming step). The molding material is a material taking on a liquid state at room temperature and is supplied in the state of room temperature. Since the center lower cavity B is in a vacuum state, by the molding material being supplied to the center upper cavity A, the center upper cavity A is filled with the molding material. On the other hand, the center lower cavity B has no space. Therefore, the decorative film 30 is deformed to the back surface 12 side of the transparent layer 10. In detail, the decorative film 30 is shaped according to the unevenness of the back surface 12 of the transparent layer 10 by the supply pressure of the molding material.

The supplied molding material is then heated by the molds 81, 82 and 83 and subjected to pressure. Therefore, the molding material supplied to the center upper cavity A is cured and the molded layer 50 is molded. At this time, the decorative film 30 is adhered to the back surface 12 of the transparent layer 10 with an adhesive. In this way, by supplying the molding material of the molded layer 50 to the molds 81, 82 and 83, the molded layer 50 is molded and at the same time, the decorative film 30 is molded to follow the unevenness of the back surface 12 of the transparent layer 10.

Moreover, simultaneously with the supply of the molding material into the center upper cavity A, as shown in FIG. 19, from the intermediate mold 82, the molding material of the sealing member 60, i.e., the thermosetting material to the outer peripheral cavity C (S17: Sealing member molding step). The molding material is a material taking on a liquid state at room temperature, and is supplied in the state of room temperature. Then, by the molding material being supplied to the outer peripheral cavity C, the outer peripheral cavity C is filled by the molding material. Then, heat and pressure by the molds 81, 82 and 83 are applied to the supplied molding material. Therefore, the molding material supplied to the outer peripheral cavity C is cured and the sealing member 60 is molded.

Subsequently, as shown in FIG. 20, the lower mold 81 and the upper mold 83 are detached from the decorative molded body 1 and the intermediate mold 82 (S18: upper-lower molds detaching step). Subsequently, as shown in FIG. 21, the intermediate mold 82 is detached from the decorative molded body 1 (S19: intermediate mold detaching step). Subsequently, as shown in FIG. 22, the mounting member 70 is mounted on the back surface of the molded layer 50 (S6b). In this way, the decorative molded body 1 is completed.

(4. Effect of the Decorative Molded Body 1)

In the decorative molded body 1, the molded layer 50 is molded from a thermosetting material. Thermosetting materials are molded by applying heat and pressure. The decorative film 30 can be formed to follow the unevenness of the back surface 12 of the transparent layer 10 by the heat and pressure during the molding of the molded layer 50. Therefore, it is possible to make the decorative film 30 follow the shape of the uneven back surface 12 of the transparent layer 10 without performing preformation and by a method different from vacuum forming or vapor deposition. As a result, the decorative molded body 1 can be made at low cost and with good design.

Further, the decorative molded body 1 comprises the frame 40 which is an element different from the sealing member 60 and the molded layer 50, it is thereby possible that the frame 40 has a frame function of the decorative molded body 1, i.e., a support function for the transparent layer 10, the decorative film 30, the molded layer 50, and the like. By making the frame 40 having the support function and the molded layer 50 different elements, it is possible to apply materials according to the respective purpose. Therefore, the decorative molded body 1 can be made at low cost and with good design, and can further have a good support function.

Furthermore, the decorative molded body 1 has the sealing member 60 at the outer peripheral side of the frame 40 on the back surface 12 of the transparent layer 10. Here, in order to dispose the decorative film 30 in a desired area on the back surface 12 of the transparent layer 10, the outer shape of the decorative film 30 is made slightly larger than the desired area. Furthermore, in order to firmly stick the decorative film 30 to the frame main body 41, the decorative film 30 protrudes to the outer peripheral side of the frame main body 41 in the sticking step (S12). However, even if the outer peripheral edge of the decorative film 30 protrudes toward the outer peripheral side beyond the desired area and the frame main body 41, the decorative film 30 is buried in the sealing member 60 at the same time as the sealing member 60 is molded. Therefore, the design of the decorative molded body 1 can be improved.

(5. Others)

In the above, the case that the molded layer 50 is molded by injection molding is given as an example. In addition to this, by disposing the molding material of the molded layer 50 in a semi-solid state in the center upper cavity A formed between the upper mold 83 and the decorative film 30 and by compression-molding it, the molded layer 50 and the decorative film 30 may be molded.

(6. Method for Manufacturing a Processed Product Using a Decorative Molded Body)

A method of manufacturing a processed product 100 using the decorative molded body 1 is described with reference to FIGS. 23 and 24. As shown in FIG. 23, the processed product 100 is molded using a decorative molded body 1a (shown in FIG. 21) without the mounting member 70, as an intermediate body, and comprises at least the transparent layer 10 and the decorative film 30 among the components of the decorative molded body 1a. In the present example, the processed product 100 comprises the paint layer 20 in addition to the transparent layer 10 and the decorative film 30. That is, the processed product 100 has a configuration in which the frame 40, the molded layer 50, and the sealing member 60 are removed from the decorative molded body 1 shown in FIG. 21.

In the method for manufacturing the processed product 100, as shown in FIG. 24, the decorative molded body 1a is first manufactured (step S20). As shown in FIG. 10, the method for manufacturing the decorative molded body 1a is the same processing as steps S1, S2, S3, S4, and S6a.

Subsequently, with respect to the manufactured decorative molded body 1a, the frame 40, molded layer 50 and the sealing member 60 are peeled off from the transparent layer 10 and the decorative film 30 to mold the processed product 100 comprising the transparent layer 10, the paint layer 20 and the decorative film 30 (step S30). In this way, the processed product 100 is manufactured. In the processed product 100, it is possible to make the decorative film 30 follow the shape of the uneven back surface 12 of the transparent layer 10. As a result, the processed product 100 can be made at a low cost and with a good design.

The decorative molded body 1a as an intermediate body for manufacturing the processed product 100 may be configured not to have the sealing member 60. Further, the decorative molded body 1a as the intermediate body may be configured not to have the frame 40.

Further, in the above, the processed product 100 does not include the sealing member 60 as an example, but may have the sealing member 60. In this case, the objects to be peeled off are the frame 40 and the molded layer 50. In this case, in step S30, the frame 40 and the molded layer 50 are peeled off from the transparent layer 10, the decorative film 30 and the sealing member 60, and the processed product 100 comprising the transparent layer 10, the paint layer 20, the decorative film 30 and the sealing member 60 is manufactured.

1. A decorative molded body comprising:
a transparent layer having an exposed surface and an uneven back surface on an opposite side of the exposed surface;
a molded layer disposed to face the back surface of the transparent layer;
a decorative film formed in a predetermined contour shape, disposed to be sandwiched between the back surface of the transparent layer and the molded layer, and formed to follow an unevenness of the back surface of the transparent layer, the decorative film being visible through the transparent layer from the exposed surface of the transparent layer; and
a sealing member disposed in a periphery shape on an outer periphery side of the decorative film and burying an outer periphery edge of the decorative film.

2. The decorative molded body according to claim 1, wherein the sealing member is disposed in a state of close contact with the transparent layer.

3. The decorative molded body according to claim 1, wherein the sealing member is molded from a thermosetting material.

4. The decorative molded body according to claim 3, wherein the thermosetting material is any one of silicone rubber, epoxy resin, or phenolic resin.

5. The decorative molded body according to claim 3, wherein the thermosetting material is a material taking on a liquid state at room temperature.

6. The decorative molded body according to claim 1, wherein the molded layer and the sealing member are molded from same material.

7. The decorative molded body according to claim 1, wherein the molded layer and the sealing member have different colors.

8. The decorative molded body according to claim 1, wherein
the molded layer is molded from a thermosetting material, and
the decorative film is disposed in a state of close contact with the molded layer.

9. A method for manufacturing the decorative molded body according to claim 1, comprising:
a film preparation step of molding the decorative film in a planar and predetermined contour shape;
a molding preparation step of, in the mold, disposing the transparent layer as an insert and disposing the decorative film of the planar and predetermined contour shape; and
a sealing member molding step of, while supplying in the mold a material of the sealing member and molding the sealing member, burying the outer periphery edge of the decorative film in the sealing member.

10. The method for manufacturing the decorative molded body according to claim 9, further comprising:
a film forming step of, while supplying in the mold a material of the molded layer and molding the molded member, forming the decorative layer to follow an unevenness of the back surface of the transparent layer.

11. The method for manufacturing the decorative molded body according to claim 10, wherein the sealing member molding step and the film forming step are performed simultaneously.
